(19) United States
(12) Patent Application Publication
(10) Pub. No.: US 2003/0146546 A1
(43) Pub. Date: Aug. 7, 2003

(54) Injection mold for plastic caps, with carriage

(75) Inventor: Bertrand Curtil, Saint-Claude Cedex (FR)

Correspondence Address: OLIFF & BERRIDGE, PLC, P.O. BOX 19928, ALEXANDRIA, VA, 22320, US

(73) Assignee: CURTIL SOCIETE ANONYME, St Claude (FR)

(21) Appl. No.: 10/309,136

(22) Filed: Dec. 4, 2002

(30) Foreign Application Priority Data
Dec. 5, 2001 (FR) 01.15728

(51) Int. Cl. B29C 45/40

(52) U.S. Cl. 264/328.7; 425/577; 425/556; 425/809

(57) ABSTRACT

The mold comprises:

a bottom plate and a top plate which can move with respect to one another in translation between a mold-open position and a mold-closed position and which define at least one cavity for the molding of a cap,

and in relation with each cavity:

a moving core,

at least two sliders for the exterior molding of the tamper-proofing band, each of which has a half-cavity of the band and which can move in translation between a position known as the molding position in which the sliders are close together and a position known as the mold-release position in which the sliders are separated,

and means of operating the translation of the sliders.

The means of operating the sliders comprise drive means and the movements of the sliders are independent of the movements of the bottom and top plates.

### BACKGROUND OF THE INVENTION

The present invention relates to the technical field of molds used for the molding, by the injection of plastic, of caps, with tamper-proofing bands, for containers.

### DESCRIPTION OF THE PRIOR ART

Such caps are, for example, described in application FR-2 718 714 or alternatively application FR-2 727 940 and generally comprise a top, a roughly cylindrical skirt provided, on its internal face, with a helical screw thread and the base of which is extended by a band forming evidence of tampering and connected to the skirt by a region of lesser strength generally delimited by a series of frangible bridges. Such caps are generally manufactured by means of a mold which comprises a bottom plate and a top plate which can move, one with respect to the other, in horizontal translation between a mold-open position and a mold-closed position. The top and bottom plates define at least one molding cavity for a cap and usually a series of cavities. The cavity part borne by the bottom and top plates corresponds therefore to the exterior surface of the cap. In order to shape the inside of the cap, especially the screw thread, if there is one, and the elements of attachment of the tamper-proofing skirt to the neck of a container, the mold comprises, in relation with each cavity, a moving core equipped, as a preference, with an elector system. Finally, the mold comprises, in relation with each cavity, at least two sliders for the external molding of the tamper-proofing band and particularly of the bridges connecting this tamper-proofing band and the skirt of the cap. To avoid any breakage of the bridges during the release of the cap from the mold, it is necessary for the sliders to be able to move in horizontal translation between a position known as the molding position in which the sliders are close together and a position known as the mold-release position in which the sliders are separated. Given that the sliders can move, it is necessary to provide, on the mold, means for operating the sliders.

Such means are, for example, described in patent FR-1 456 836. According to that document, the operating means comprise inclined fingers borne by the top plate of the mold and intended to engage in bores, also inclined, of the moving sliders. The slope of the fingers and of the bores is therefore designed so that, during a mold-closing movement by the upper plate moving closer against the bottom plate, engagement of the fingers in the bores causes the sliders that mold the tamper-proofing band to move closer together. Conversely, as the mold is opened, the disengagement of the fingers from the bores causes the sliders to move apart.

Such a device is satisfactory in its function of opening and closing the sliders and does, however, have the disadvantage of being particularly fragile. This is because poor engagement of the fingers of the top plate in the bores of the sliders is likely to cause breakage of the fingers, usually accompanied by damage to the elements nearby.

In order to remedy this disadvantage, a patent, FR-2 080 466, describes an inclined ramp system secured to the sliders and fitted on the outside of the mold into which guide fingers borne by the top plate engage. Thus, during a mold-closure movement, by moving the top plate closer to the bottom plate, engagement of the fingers in the slots causes a closing-up translational movement of the sliders. Conversely, opening the mold causes the sliders to move apart.

The prior art has also envisioned providing, for operating the sliders, in the rear part thereof, an inclined heel intended to co-operate with a wedge or a heel, also inclined, borne by the top plate so that, as the mold is closed, the contact between the heels of the plate and of the sliders causes the latter to close together.

These devices do actually make it possible to close and open the sliders, at the same time reducing the risks of breakage by comparison with the system of operation employing projecting fingers. However, such systems have the disadvantage of giving rise to knocks as the mold closes, which means that it is necessary to limit the speed of travel of the top plate with respect to the bottom plate and with respect to the sliders it bears.

### SUMMARY OF THE INVENTION

There has therefore arisen a need for a novel system for opening and closing the sliders used for molding the tamper-proofing bands which makes it possible to increase the rate at which the mold can be used by reducing the cycle time and more particularly the time taken to open and close the sliders, while at the same time limiting the risks of breakage and the phenomena of wear.

In order to achieve this objective, the invention relates to a mold for the injection-molding of caps with tamper-proofing bands made of plastic, of the type comprising:

a bottom plate and a top plate which can move with respect to one another in translation between a mold-open position and a mold-closed position and which define at least one cavity for the molding of a cap,

and in relation with each cavity:

a moving core,

at least two sliders for the external molding of the tamper-proofing band, each of which has a half-cavity of the band and which can move in horizontal translation between a close-together molding position, known as the close-together position, and a separated position known as the mold-release position,

and means of operating the translation of the sliders.

According to the invention, this mold is one wherein the means of operating the sliders comprise drive means and wherein the movements of the sliders are independent of the movements of the bottom and top plates.

According to a preferred feature of the invention, the means of operating the two sliders, which are associated with one and the same cavity, are actuated by one and the same drive means.

The drive means may be produced in any appropriate way provided that they are able to move the slides independently of the movements of the bottom and top plates.

Thus, the drive means may consist of one or more mechanical rams, such as hydraulic or pneumatic or alternatively electric rams. The drive means may also consist of systems of operation involving an electric motor of an electromagnet.

According to another feature of the invention, the means of operating the slides comprise cams acting on the slides.

According to a preferred embodiment of the invention, the sliders are guided in translation in at least one slideway of axis X-X′ formed on the bottom plate. The operating means then comprise at least two slides which are guided in slideways of axis Y-Y′ perpendicular to the axis X-X′ and which are secured to a carriage moved in translation by a drive means. Each slide is then connected to at least one slider so that translation of a slide causes reciprocal translation of the corresponding slider.

As a preference, but without this being strictly essential, each slider therefore comprises at least one straight slot of axis Δ oblique or inclined with respect to the axis X-X′. This slot of the slider is then intended to accommodate an operating finger borne by a slide.

According to the invention, the mold may comprise several cavities arranged one beside the other, and the slides for operating the sliders are then all secured to one and the same carriage so as to allow all the sliders of the mold to be operated simultaneously.

The invention also relates to a method for the injection-molding of caps with tamper-proofing bands, and which consists in using a mold according to the invention and in causing the sliders to move into a separated position after plastic has been injected and before the mold is opened by parting the bottom and top plates.

### BRIEF DESCRIPTION OF THE DRAWINGS

Various other features of the invention will become apparent from the description hereinbelow, given with reference to the appended drawings which illustrate a non-limiting exemplary embodiment of a mold according to the invention.

FIG. 1 is schematic section of a mold according to the invention, in the closed position.

FIG. 2 is a view, on II-II, of the bottom plate of the mold as illustrated in FIG. 1.

FIG. 3 is a cross section similar to FIG. 1, showing the mold in the open position.

FIG. 4 is a view from above of sliders for molding the tamper-proofing band according to the invention.

FIG. 5 is a view in section on V-V of FIG. 4.

FIG. 6 is a view from above on VI-VI of FIG. 3 of the bottom plate of the mold according to the invention.

FIG. 7 is a cross section similar to FIG. 1 showing an alternative form of embodiment of a mold according to the invention.

### DESCRIPTION OF THE PREFERRED EMBODIMENTS

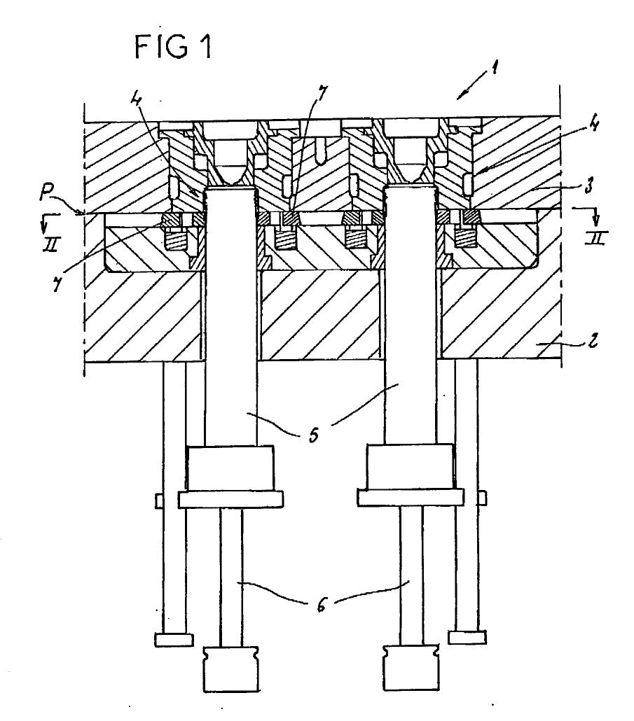

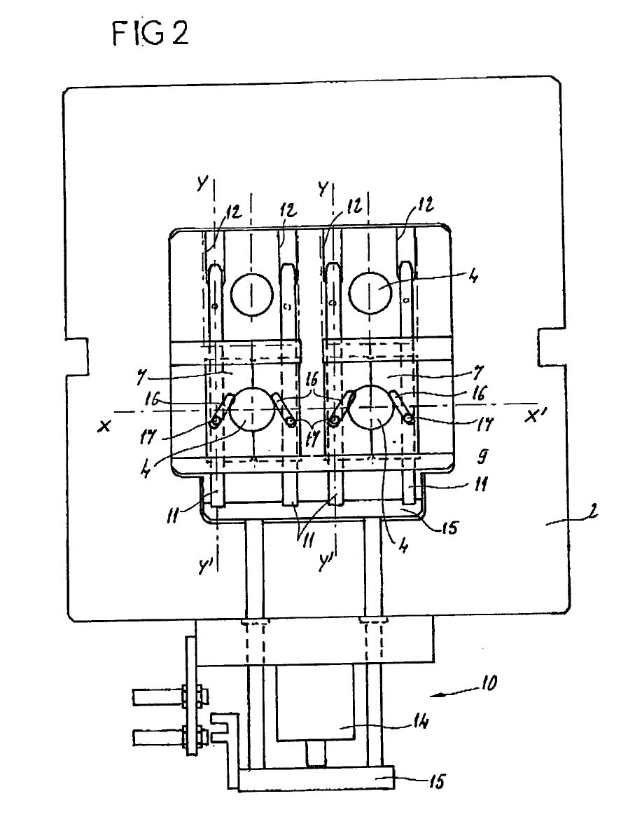

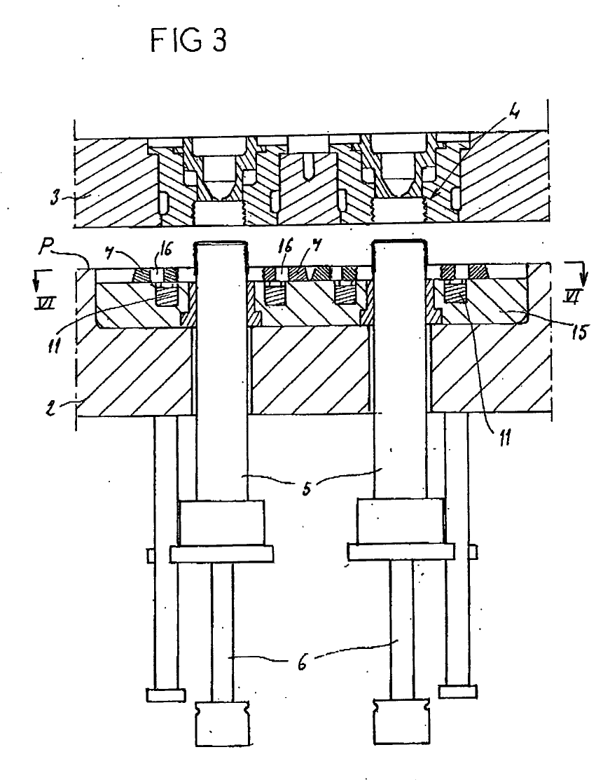

As is apparent from FIGS. 1 and 2, a mold according to the invention, denoted in its entirety by the reference 1, comprises a bottom plate 2 and top plate 3. The bottom plate 2 and top plate 3 can move with respect to one another in translation between a mold-closed position as illustrated in FIG. 1, and an open position depicted more particularly in FIG. 3. The means of operating and of supporting the plates 2 and 3, not depicted, generally belong to the injection-molding machine and fall within the general competence of a person skilled in the art. In the example illustrated, to make the depiction easier, the opening movement corresponds to a vertical translational movement. However, when the mold is in place on an injection-molding machine, the mold is opened by a horizontal translational movement.

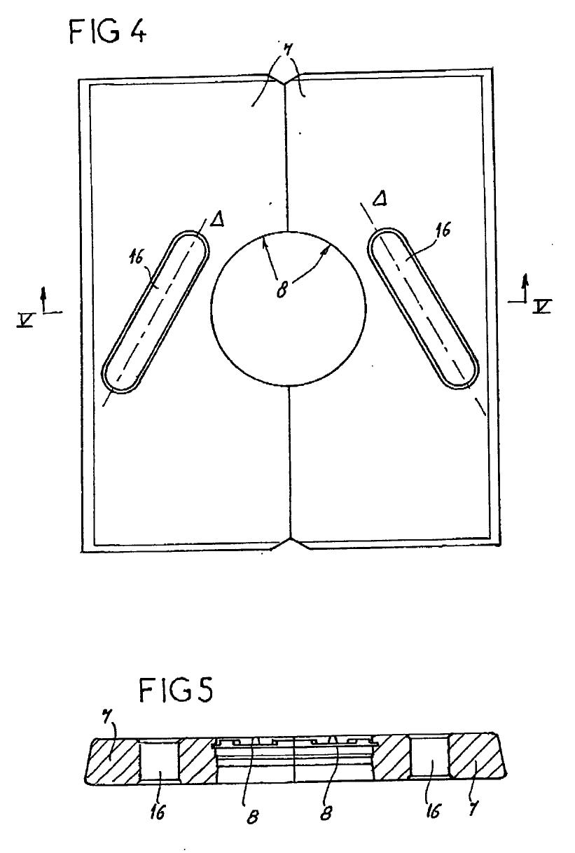

The bottom plate 2 and top plate 3 together define at least one and in the example illustrated four cavities 4, each intended for the injection-molding of a plastic cap. The mold 1 comprises, in association with each cavity 4, a core 5 that can move with respect to the bottom plate 2 and is equipped with an injector 6 to allow the molding and mold-release of the tamper-proofing band or of undercut exterior parts of the cap, and the mold 1 comprises, in relation with each cavity 4, at least two sliders 7 which, as shown by FIGS. 4 and 5, each have a half-cavity 8. In the example illustrated, the half-cavities 8 form an integral part of each slider 7.

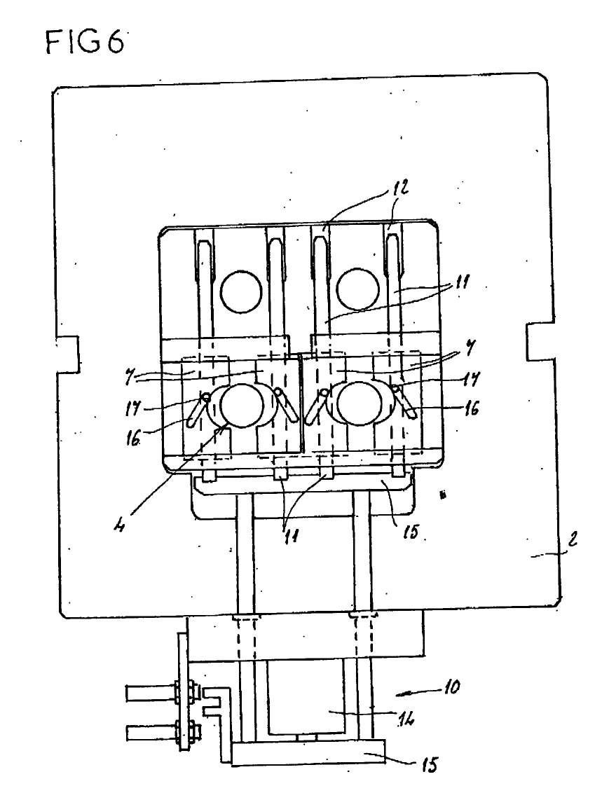

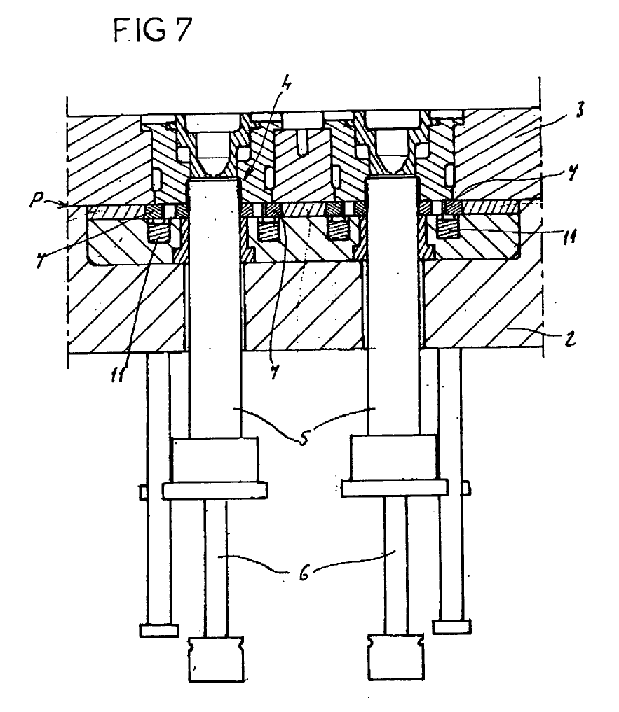

Given the undercut relief of the exterior part of the tamper proof band, it is necessary to be able to part the sliders in order to disengage the tamper-proofing band and release it from the mold without the risk of breakage. Thus, the sliders 7 have to be able to move in translation parallel to the parting line of the mold, between a close-together molding position as illustrated in FIG. 2, and a mold-release position in which the sliders 7 are separated from one another, as shown by FIGS. 3 and 6. Thus, the sliders 7 are, in the example illustrated, able to move in horizontal translation of axis X-X′ and guided for that purpose in a slideway 9 formed in the bottom plate 2. It should be noted that, according to the example illustrated, the same slideway 9 guides the translation of two pairs of sliders 7 of two cavities 4 situated one beside the other.

According to one essential feature of the invention, in order to provide the movements of the sliders 7, the mold 1 is equipped with means 10 of operating the sliders 7 to move them between their molding position and their mold-release position. According to the example illustrated, the operating means 10 comprise, in relation with each slider 7, a slide 11, guided in a slideway 12 of axis Y-Y′ perpendicular to the axis X-X′ and formed in the bottom plate 2 under the sliders 7. It should be noted that, in the example illustrated, the slides 11 are associated with two sliders of two distinct cavities, aligned in the direction Y-Y′. The slides 11 are all secured to one and the same carriage 15 which is moved in translation by a drive means 14, such as a pneumatic ram, between an extended position, as illustrated in FIG. 2, corresponding to a closed or close-together position of the sliders 7 and a retracted position, as illustrated in FIG. 6, corresponding to a position known as the mold-release position, in which the sliders 7 are separated.

In order to convert the translational movement of the slides 11 into an opening or closing of the sliders 7, the invention anticipates employing a cam-type connecting system between the slides 11 and the sliders 7. According to the example illustrated, this cam system comprises a slot 16 formed in each slider 7, so as to have an orientation that is oblique or inclined with respect to the axis X-X′ of translation of the sliders. Each slide 11 therefore has a peg or finger 17 intended to cooperate with a slot 16 of a slider. Thus, the connection between the finger 17 and the corresponding slot 16 of a slider allows a translational movement of axis Y-Y′ of the slides 11 to be converted into a reciprocal translational movement of axis X-X′ of the sliders.

When the mold 1 is used and given the design of the operating means 10 which involves drive means 16, it is possible to cause the sliders to effect an opening and closing movement independently of the position or of the movement of the bottom plate 2 and top plate 3 of the mold 1.

Thus, for example, it is possible, having injected the plastic of which the caps are made into the cavities 4, to open the sliders 7 before opening the mold 1. Likewise, it is possible to close the sliders before closing the mold 1. This independence between the movements of the sliders 7 and the movements of the bottom plate 2 and top plate 3 of the mold 1 therefore makes it possible to increase the molding rates and therefore optimize the use of the mold.

In addition, the use of drive means 16 specific to the sliders, avoids jolts and knocks that carry risks of breakage, as was the case with the slider-operating systems of the prior art.

According to the example illustrated, the autonomous operation of the sliders 7 is performed with slide systems. However, according to the invention, it could be envisioned for use to be made of any other cam-operated or otherwise system of operation, provided that this system of operation comprises drive means able to cause the sliders to move independently of the movements of the bottom plate 2 and top plate 3. Thus, it could be envisioned for means of operating the corresponding sliders 7 to be associated with each cavity.

According to the example illustrated and described above, the movements of the sliders may be performed when the mold is in the closed position.

According to an alternative form of embodiment illustrated more specifically in FIG. 8, the top plate comprises locking keys intended to impede the movements of the sliders when the mold is in the closed position. This arrangement then avoids any inadvertent movements of the sliders while the plastic is being injected. In this case, the sliders 7 are opened, after a short opening of the mold, so as to release from the locking keys.

Of course, the invention is not restricted to the examples described hereinabove and various modifications can be made thereto without departing from its scope.

1. A mold for the injection-molding of caps with tamper-proofing bands made of plastic, of the type comprising:
a bottom plate and a top plate which can move with respect to one another in translation between a mold-open position and a mold-closed position and which define at least one cavity for the molding of a cap,
and in relation with each cavity:
a moving core,
at least two sliders for the external molding of the tamper-proofing band, each of which has a half-cavity of the band and which can move in translation between a position known as the molding position in which the sliders are close together and a position known as the mold-release position in which the sliders are separated,
and means of operating the translation of the sliders,
wherein the means of operating the sliders comprise drive means and the movements of the sliders are independent of the movements of the bottom and top plates.

2. The mold as claimed in claim 1, wherein the means of operating the two sliders, which are associated with one and the same cavity, are actuated by one and the same drive means.

3. The mold as claimed in claim 1 or 2, wherein the means of operating the sliders comprise cams acting on the sliders.

4. The mold as claimed in one of claims 1 to 3, wherein the sliders are guided in translation in at least one slideway of axis X-X′ and wherein the operating means comprise at least two slides which are guided in slideways of axis Y-Y′ perpendicular to the axis X-X′ which are secured to a carriage moved in translation by a drive means and which are each connected to at least one slider so that translation of a slide causes reciprocal translation of the corresponding slider.

5. The mold as claimed in claim 4, wherein each slider comprises at least one straight slot of axis Δ inclined with respect to the axis X-X′ and intended to accommodate an operating finger borne by a slide.

6. The mold as claimed in claim 4 or 5 and which comprises several cavities, wherein the slides for operating the sliders are all secured to one and the same carriage so as to allow all the sliders of the mold to be operated simultaneously.

7. The mold as claimed in one of claims 1 to 6, wherein the means of driving the operating means comprise a ram.

8. A method for the injection-molding of caps with tamper-proofing bands, and which consists in:
using a mold as claimed in one of claims 1 to 7, and
causing the sliders to move into the close-together position before the mold is closed.

9. The molding method as claimed in claim 8 and which consists in causing the sliders to move into a separated position after the plastic has been injected and before the mold is opened.

10. The molding method as claimed in claim 8 and which consists in causing the sliders to move into a separated position after the plastic has been injected and after a very short opening of the mold.
